(19) United States
(12) Patent Application Publication
(10) Pub. No.: US 2019/0205074 A1
(43) Pub. Date: Jul. 4, 2019

(54) System and Methods of Managing Incoming Facsimile Messages in a Networked System

(71) Applicant: Lexmark International, Inc., Lexington, KY (US)

(72) Inventors: Thomas L. Coons, Richmond, KY (US); Craig A. Rudolph, Shelbyville, KY (US)

(21) Appl. No.: 16/050,902

(22) Filed: Jul. 31, 2018

Related U.S. Application Data
(63) Continuation-in-part of application No. 15/856,560, filed on Dec. 28, 2017.

(51) Int. Cl. G06F 3/12; H04N 1/32; H04N 1/00; G06F 17/30

(52) U.S. Cl. CPC G06F 3/1263; H04N 1/32411; G06F 17/30997; G06F 3/1207; H04N 1/001

(57) ABSTRACT

A system and methods of managing incoming fax messages at a multi-function imaging device connected to a network are disclosed. One example method includes receiving a fax message at the multi-function imaging device and identifying a workflow connected to the network based upon a content of the fax message. A type of the fax message may be identified based upon the content of the fax message and may be used to identify the workflow. A recipient of the fax message is then determined based upon the identified workflow. Upon identification of the recipient of the fax message, the imaging device adds the fax message to an imaging queue associated with the recipient in a print server communicatively connected to the imaging device.

### CROSS REFERENCES TO RELATED APPLICATIONS

This patent application claims the benefit of the earlier filing date of U.S. patent application Ser. No. 15/856,560, entitled “System and Methods of Managing Incoming Facsimile Messages in a Networked System”, filed Dec. 28, 2017, the contents of which is hereby incorporated by reference herein in its entirety.

### STATEMENT REGARDING FEDERALLY SPONSORED RESEARCH OR DEVELOPMENT

None.

### REFERENCE TO SEQUENTIAL LISTING, ETC.

None.

### BACKGROUND

### 1. Technical Field

The present invention relates generally to a system and methods of managing incoming facsimile messages. Specifically, the present invention refers to a system and methods for securely managing facsimile messages in a networked system.

### 2. Description of the Related Art

Generally, a multi-function peripheral device (“MFP”) may include various functions of existing office equipment, such as scanning, facsimile (“fax”), printing, and/or copying integrated into a single device and may be used independently, or in association with a computer. Typically, for MFPs that are connected to a fax line and are capable of receiving fax from a sender, incoming fax messages are automatically printed by the MFP when the MFP receives the fax messages. While current fax transmission systems provide a useful means of communicating documents and other information to respective recipients through MFPs, automatic printing of the fax messages may present some problems.

In corporations or enterprises with multiple users that utilize the MFP as the receiving fax machine, fax messages that are directed to the users may be received and automatically printed at the MFP. In some instances, the recipient user may not be notified of the receipt or printing of the fax document, and the printed document may remain on an output tray of the MFP for a period of time. For fax documents that contain sensitive or confidential information, this may pose as a security risk. For fax documents used as part of a business process, such as where fax documents are utilized to place orders or collect revenue, this may add delay to the business process, which may result in negatively impacting the business or organization. Further, fax messages that do not have business value and do not need to be printed are automatically printed at the MFP, resulting in unnecessary and wasteful printing which can be an economic disadvantage to the corporation.

Thus, there is a need for a secure and optimized management of incoming fax messages in an MFP. There is also a need to efficiently manage incoming fax messages in MFPs utilized by one or more users in a network.

### SUMMARY

A system and methods for managing fax messages received at an imaging device connected to a network are disclosed. One example method for managing incoming fax messages may include receiving at the multi-function imaging device a fax message from a transmitting fax machine and determining an intended recipient of the fax message. The multi-function imaging device may identify if intended recipient is a registered user in the network. Each of the registered users is associated with an imaging or work queue for storing one or more imaging jobs. If the intended recipient is identified as a registered user of the network, the fax message may be added to the user's imaging or work queue. Identifying the intended recipient of a fax message in an imaging device may be based upon a workflow system identified based upon a content of the fax message. In one example embodiment, the workflow system for processing the fax message may be determined based upon a type of the fax message. The one or more recipients of the fax message may be one or more predetermined users of the workflow system identified.

From the foregoing disclosure and the following detailed description of various example embodiments, it will be apparent to those skilled in the art that the present disclosure provides a significant advance in the art of managing incoming fax messages. Additional features and advantages of various example embodiments will be better understood in view of the detailed description provided below.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 is one example system for securely and efficiently managing incoming fax messages in a network.

FIG. 2 is an example method for managing incoming fax messages in the example networked system of FIG. 1.

FIG. 3 is another example system for securely and efficiently managing incoming fax messages in a network.

FIG. 4 is another example method for managing incoming fax messages in the example networked system of FIG. 3.

### DETAILED DESCRIPTION OF THE DRAWINGS

It is to be understood that the disclosure is not limited to the details of construction and the arrangement of components set forth in the following description or illustrated in the drawings. The disclosure is capable of other example embodiments and of being practiced or of being carried out in various ways. For example, other example embodiments may incorporate structural, chronological, process, and other changes. Examples merely typify possible variations. Individual components and functions are optional unless explicitly required, and the sequence of operations may vary. Portions and features of some example embodiments may be included in or substituted for those of others. The scope of the disclosure encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Further, the use of the terms “a” and “an” herein do not denote a limitation of quantity but rather denote the presence of at least one of the referenced item.

In addition, it should be understood that example embodiments of the disclosure include both hardware and electronic components or modules that, for purposes of discussion, may be illustrated and described as if the majority of the components were implemented solely in hardware.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block or combinations of blocks in the diagrams discussed in detail in the description below.

These computer program instructions may also be stored in a non-transitory computer-readable medium that may direct a computer or other programmable data processing apparatus to function in a particular manner, such that the instructions stored in the computer-readable medium may produce an article of manufacture, including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the diagrams support combinations of means for performing the specified functions, combinations of steps for performing the specified functions and program instruction means for performing the specified functions. It will also be understood that each block of the diagrams, and combinations of blocks in the diagrams, may be implemented by special purpose hardware-based computer systems that perform the specified functions or steps or combinations of special purpose hardware and computer instructions.

Disclosed are an example system and example methods for managing incoming fax messages at a multi-function imaging device connected to a network. One example method for managing incoming fax messages may include receiving at the multi-function imaging device a fax message from a transmitting fax machine. In one example embodiment, the imaging device may determine a recipient of the received fax message based upon a metadata of the fax message. In another example embodiment, the imaging device may determine a workflow system associated with the received fax message based upon a content of the fax message. In this example embodiment, the workflow system may be based upon a type of the fax message determined. For example, where the type of the fax message is determined to be a medical record, the imaging device may add the fax message to a healthcare workflow system handling medical records. The imaging device may then identify one or more predetermined recipients of the received fax message in the healthcare workflow system. Following identification, the fax message may be added to a print queue of the identified recipients.

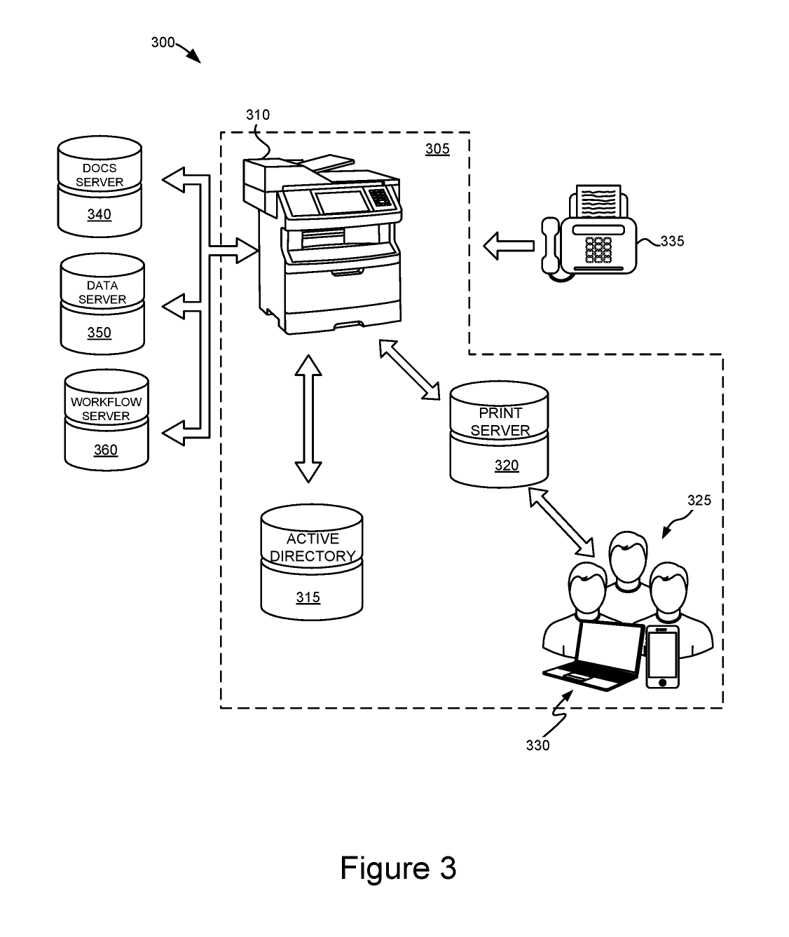

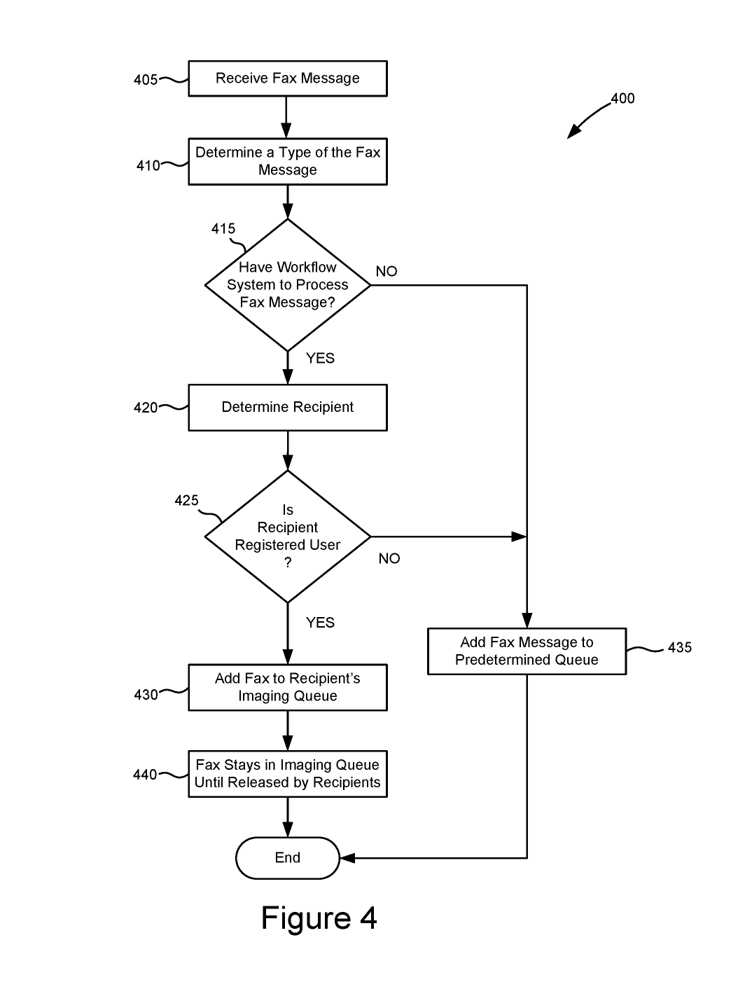

In one example embodiment, an intended recipient of the fax message may be determined from a metadata of the fax message. In some other example embodiments, an intended recipient of the fax message may be determined based upon the workflow system associated with the fax message (see, e.g., FIGS. 3 and 4 below). The intended recipient may be checked against a list of one or more authorized or registered users in the network, and each of the registered users may have a data structure such as, for example, an imaging or work queue for storing one or more scan, imaging, copy and/or facsimile jobs. If the intended recipient is determined to be a registered user of the network, the fax message may be added to such user's imaging queue. Adding the fax message to the user's imaging queue allows the user to control disposition of the fax message. For example, by storing the incoming fax message in the user's imaging queue, the user is able to control whether to delete the fax message without printing, whether to print the fax message, when to process the fax message (e.g., when to print or e-mail the fax message, etc.) and/or whether to further process the fax message, such as by leveraging advanced Optical Character Recognition (OCR) technology to assess and associate where to further transmit the fax message, such as by e-mailing or sending to another storage medium, such as an electronic content management system for further processing. One such example of further processing is determining a type of the incoming fax message (e.g., a purchase order, etc.) and, in addition to or instead of printing the fax message, the fax message contents may be sent to and further processed by a workflow system (e.g., an accounting system) communicatively connected to the imaging device.

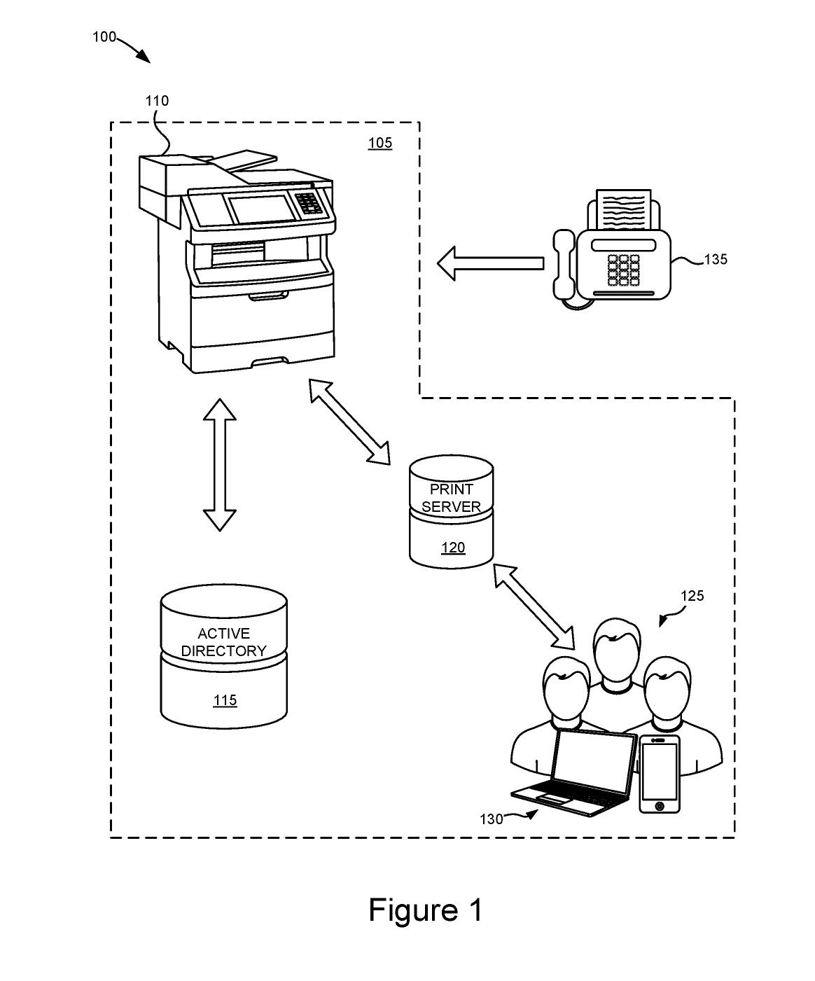

FIG. 1 is one example system for securely and efficiently managing incoming fax messages in a network. Example system 100 includes a network 105 having at least one imaging device 110, an active directory 115 communicatively connected to imaging device 110, a print server 120, and one or more users 125. In one example embodiment, network 105 may be a print release computing environment where users 125 view, create, and/or modify documents using one or more client computing devices 130 such as smart phones, laptop computers, desktop computers, tablets, and the like, and users 125 may wish to obtain imaged media corresponding to such documents using at least one imaging device 110 from network 105.

Imaging device 110 may be, but is not limited to, a printer, copier, fax machine, all-in-one machine, or multi-function peripheral device (MFP), etc. Imaging device 110 may be a device configured to conduct facsimile communication such as the sending and/or receiving of images and written material from a transmitting fax machine 135 over a communication channel such as a telephone line, a network, a wireless link, and the like. Imaging device 110 may include a facsimile module (not shown) that includes executable instructions for decoding fax data received from transmitting fax machine 135 and processing the fax data to generate imaging data to be printed. Imaging device 110 may communicate with print server 120 to retrieve one or more imaging jobs for imaging, as will be described in greater detail below.

Active directory 115 is a computing device, such as a server, but may typify other devices such as an LDAP server, a directory service, a storage volume, general purpose computer, a controller, database, etc. Active directory 115 defines a list of users 125, in an entity available or allowed to participate in the print release environment provided by network 105. Such users 125 may be clients, employees, contractors, partners, vendors, or anyone else permitted by the organization or enterprise to use network 105. Users 125 who are defined or registered with active directory 115 may be assigned an imaging queue that stores one or more imaging jobs initiated by the user. The imaging queue may be stored at print server 120 communicatively connected with imaging device 110. In some example embodiments, the imaging queue may correspond to a unique individual. In other example embodiments, the imaging queue may correspond to a particular group of individuals.

Each user 125 may initiate the imaging of items such as documents on client device 130. The items may be bundled together in an imaging job and include the requisite details of the item to be imaged along with metadata. The bundled items may then be packaged into an appropriate printer language for imaging device 110, such as Printer Command Language (PCL), Postscript, etc., as will be known in the art. Client device 130 may be used to initiate the imaging of items. For example, client device 130 may forward the imaging or a print job to print server 120, as is known in a print release environment.

In one example embodiment, a user 125 may be registered with active directory 115. Users registered with active directory 115 may be assigned with an imaging queue that stores or manages one or more imaging jobs that the user has forwarded to print server 120. When user 125 wishes to obtain a hard-copy of the imaging job at imaging device 110, user 125 may authenticate or log in at imaging device 110 to verify that the user is registered with active directory 115. If a user is registered with active directory 115, user 125 may be permitted to print or “release” an imaging job using imaging device 110. Upon successful authentication, imaging device 110 may communicate with print server 120 to access the corresponding imaging queue of the logged-in user and print or otherwise process the one or more imaging jobs stored in the imaging queue, as requested by the user.

In this example print release environment, print server 120 holds or stores the imaging jobs until users 125 initiate the printing of the imaging jobs at one of imaging devices 110 in network 105. In one example embodiment, print server 120 may store the imaging jobs for a predetermined amount of time such that, after the predetermined amount of time has elapsed, the imaging jobs may be deleted from the imaging queue of the user. Utilizing print server 120 in a print release environment securely manages imaging jobs such that the hard copies of sensitive documents are not printed until users authenticate themselves at imaging device 110 and request printing of the job. Print server 120 may also track printing habits and enforce compliance with established policies. For example, there may be a policy where no frivolous or unimportant documents are accidentally printed. In some example aspects, the company may desire that all incoming fax messages be only printed in black and white and/or leverage other advanced printing features to manage and control output spend and overall align with sustainability efforts. This technique holds users 125 accountable for the imaging of documents and prevents accidental release of hard copies to others.

Network 105 may be a local area network (LAN) or wide area network (WAN) that communicatively connects imaging device 110, active directory 115, print server 120, and client devices 130 together. Network 105 includes a variety of software to send and receive packets of information. Network 105 also includes hardware, such as routers, servers, switches, general or special purpose computers, transmission and relay towers, satellites, fiber optics, phone lines, cables, etc. The connections may be wired, wireless or a combination of wired and wireless communications between a few or many such hardware devices via an internet, intranet or other surrounding. Network 105 connects the devices in any configuration, not just the example configuration shown in FIG. 1.

Transmitting fax machine 135 may be any device capable of transmitting or sending fax messages, such as scanned printed material containing at least one of text and images. Transmitting fax machine 135 typically sends fax messages to a telephone number connected to a printer or other output device such as imaging device 110. Typically, fax machine 135 receives an original document from a computing device, a scanner, or telecopier; processes the message as a single fixed graphic image; converts the message into a bitmap; and transmits the message through a telephone system as a fax message to an intended recipient. A receiving fax machine or an MFP such as imaging device 110 may receive the message, interpret the signals sent through the telephone system, and reconstruct the image. The image may then be printed to a media, thereby resulting in a hard-copy of the fax document. In one example embodiment, transmitting fax machine 135 may send a fax message having metadata, which may include, for example, an intended recipient for the fax message, a telephone number to which the fax message will be sent, a title of the message, and other pertinent information.

In one example embodiment, transmitting fax machine 135 may send a fax message to network 105 to be printed by imaging device 110. The recipient of the fax message may be one of users 125 of network 105. In one example aspect, the telephone number to which the fax message is sent may be associated with imaging device 110 such that imaging device 110 receives the fax message and is expected to print the fax message upon receiving the fax message from transmitting fax machine 135. In another example aspect, network 105 may include a fax server (not shown) that allows users 125 whose client devices 130 are attached to the LAN to receive fax messages and print the fax messages using an associated imaging device such as imaging device 110.

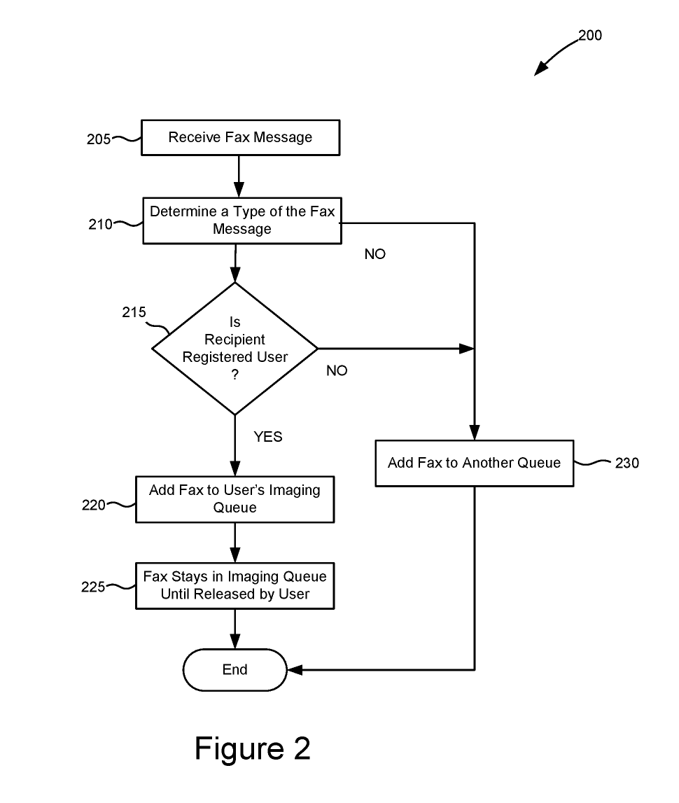

FIG. 2 is one example method 200 for managing incoming fax messages in the example networked system 100 of FIG. 1. For illustrative purposes, example method 200 may be performed by imaging device 110 in system 100. Imaging device 110 may have a processor for executing one or more instructions for managing fax messages received from transmitting fax machine 135. In another example aspect, example method 200 may be performed by a fax server that receives incoming fax messages from transmitting fax machine 135.

At block 205, an incoming fax message may be received by imaging device 110. The fax message may be sent by transmitting fax machine 135 and received by imaging device 110 through a fax line, as is known in the art. In one example embodiment, the fax message may include metadata. For example, metadata information may include an intended recipient of the message, a title, and/or a recipient telephone number, among others. The intended recipient of the message may be a name of the recipient, an e-mail address of the recipient or another unique identifier associated with user 125.

At block 210, imaging device 110 may determine a recipient of the fax message from the metadata of the incoming fax message and identify if the determined recipient is a user registered to active directory 115 (at block 215). Upon receiving the fax message, imaging device 110 may inspect the message to determine whether such the fax message contains metadata, and upon positive determination, imaging device 110 may read the metadata to determine if a recipient is indicated in the fax message.

At block 215, imaging device 110 may then determine if the recipient indicated in the fax message is a user registered to active directory 115 (at block 215). Determining if the recipient is a registered user in active directory 115 may include sending a query to active directory 115 to check whether a user in active directory 115 matches at least one of a name or an e-mail address indicated as a recipient in the metadata.

Upon determining that the recipient of the fax message is a registered user in active directory 115, the incoming fax message may be added to such user's imaging queue at block 220. Adding the fax message to the imaging queue of the recipient may be performed by sending the fax message to print server 120. Print server 120 may store the imaging queues of the users registered in active directory 115, and enqueues the fax message as an imaging job in user 125 or recipient's imaging queue. In one example embodiment, user 125 may be notified (e.g., by e-mail) of the fax message addressed to user 125. In another example embodiment, user 125 may be notified when a fax message is added to the imaging queue of user 125.

Once added to the user's imaging queue, the fax message remains in the imaging queue until user 125 approaches imaging device 110 and controls imaging device 110 to print or “release” the fax message in order to obtain a hard-copy of the fax message. In one example embodiment, user 125 may be able to see a preview of the queued fax message so that the user may check or otherwise examine the contents of the fax message prior to deciding whether or not to print the fax message. As discussed above, when user 125 wishes to print the fax message, user 125 logs into imaging device 110 to access his or her imaging queue and selects the fax message from the imaging queue for printing by imaging device 110.

If at block 210, imaging device 110 is unable to determine a recipient of the fax message such as, for example, when the intended recipient of the fax message is a telephone number or a corporation and not an individual, or if the fax message did not indicate a recipient, imaging device 110 may add the fax message to another predetermined imaging queue (block 230). Similarly, if at block 215, imaging device 110 determined that the recipient of the fax message is not a user registered to active directory 115, the fax message may be added to another imaging queue (block 230).

The predetermined imaging queue may be, for example, a dedicated imaging queue for handling incoming fax messages received by one or more imaging devices 110 of network 105. The dedicated imaging queue for handling incoming fax messages with no identified recipients may be used to store fax messages prior to being released by an authorized user such as, for example, a network or device administrator. Incoming fax messages that may be identified as spam or advertisements may also queued to the dedicated imaging queue and reviewed by the network administrator prior to being printed or processed. The administrator may manage the imaging queue and may be notified of the new fax message received by network 105 and may authorize the release of the fax message for printing at imaging device 110. The network administrator may control the printing of the fax message as is typical in a print release environment.

FIG. 3 is another example system 300 for securely and efficiently managing incoming fax messages in a network 305. Example system 300 may include the same or similar components to those in system 100 in FIG. 1. Example system 300 may include network 305, at least one imaging device 310, an active directory 315, a print server 320, one or more users 325 using corresponding client computing devices 330, and transmitting fax machine 335 which may be the same or similar to network 105, imaging device 110, active directory 115, print server 120, users 125 using client computing devices 130, and transmitting fax machine 135 in FIG. 1, respectively. In addition, as shown in FIG. 3, imaging device 310 may be communicatively connected to a documents server 340, a predetermined data server 350, and a workflow server 360.

Documents server 340 may include a plurality of predetermined types of documents classified according to how information may be arranged in the documents. An arrangement of information in the received fax message may be compared with each type of document stored in documents server 340 to determine the type of the fax message received. Predetermined data server 350 may include a set of predetermined data (e.g., words, phrases, logos, images, etc.) for comparing with data detected in the received fax message. Each predetermined data may be associated with a predetermined type of document stored in documents server 340 and/or a workflow system stored in workflow server 360. Workflow server 360 may include different workflow system types. Each workflow system may be associated with one or more predetermined types of documents stored in documents server 340 and/or a set of predetermined data stored in predetermined data server 350.

FIG. 4 is another example method 400 for managing incoming fax messages in the example networked system of FIG. 3. Example method 400 will now be described as being performed by imaging device 310. However, it is to be understood that in some other example embodiments, a server (not shown) may receive fax messages from transmitting fax machine 335 and may forward the fax message to imaging device 310.

At block 405, an incoming fax message may be received by imaging device 310. The fax message may be sent by transmitting fax machine 335 and received by imaging device 310 through a fax line, as is known in the art. In one example embodiment and as discussed above with respect to FIG. 2, the fax message received may include metadata. For example, metadata information may include an intended recipient of the message, a title, and/or a recipient telephone number, among other information. The intended recipient of the message may be a name of the recipient, an e-mail address of the recipient or any other unique identifier associated with user 325 or group of users.

At block 410, imaging device 310 may determine a type of the fax message. The type of the fax message may be determined based upon a content of the fax message. A content of the fax message received at block 405 may be processed by imaging device 310, such as, for example, via OCR. In one example embodiment, the type of the fax message may be determined based upon an arrangement of data in the fax message.

Imaging device 310 may determine the type of the fax message based upon how data is arranged therein by querying documents server 340. Imaging device 310 may determine whether an arrangement of content in the fax message matches or is otherwise similar to an arrangement of a predetermined document type stored in documents server 340. For purposes of example and not of limitation, documents server 340 may store a document as a medical record, an insurance record, an invoice, an order form, or any other type of document that is known in the art. In some example embodiments, documents server 340 may store predetermined or customized arrangements of data. Imaging device 310 may compare the arrangement or format of content in the fax message received by imaging device 310 with arrangements or formats of documents and data stored in documents server 340 to determine a document classification or type of the fax message received from transmitting fax machine 335.

In some other example embodiments, the type of the fax message may be determined based upon data or content extracted from the received fax message. Imaging device 310 may be communicatively coupled to predetermined data server 350 to perform this determination. For example, following receipt of the fax message at block 405, imaging device 310 may include at least one instruction to extract a word(s), an image(s), and/or other data from the content of the received fax message to determine whether the word(s), image(s) and/or other data is associated with a type of document stored in documents server 340 by comparing the extracted data or content with predetermined data stored in predetermined data server 350 to determine the fax message type.

In one aspect of this example embodiment, words extracted from the received fax message may include an e-mail address, a department name, a person's name, name of a business organization or entity, and/or other predetermined names or information. In another aspect of this embodiment, the extracted words may include a set of predetermined words, such as, for example, “hospital”, “account”, “purchase” and the like. Data stored in predetermined data server 350 may be associated with a predetermined type of document stored in documents server 340. For example, imaging device 310 may classify the received fax message as a health record document when the word “health” has been cited more than a predetermined number of times in the fax message. Imaging device 310 may query predetermined data server 350 when an arrangement of content in the fax message is not recognized, i.e., not found in documents server 340.

At block 415, imaging device 310 may identify whether a workflow system for processing the fax message exists. In one example embodiment, the workflow system associated with the received fax message may be based upon the fax message type determined at block 410. Imaging device 310 may be communicatively connected to workflow server 360. Workflow server 360 may include a set of predetermined workflow system types such as, for example, a healthcare workflow, an accounting workflow, an insurance claims workflow, etc. Other types of workflow systems may be added into workflow server 360.

For each type of workflow system, an administrator or other user may identify one or more authorized users. Thus, each workflow system type stored in workflow server 460 may have one or more pre-identified authorized users. The one or more pre-identified users for each workflow system type may include one or more users 325. The one or more users may be identified or prioritized in a desired order. For example, in some example aspects, the administrator may identify a first user to process a message in a first predetermined manner and a second user to process the message in the event that the first user is not a registered user in active directory 315. In other example aspects, the administrator may identify a first user to process the received fax message in a first predetermined manner and a second user to further process the received fax message in a second predetermined manner.

Workflow server 360 may store not only a set of workflow systems but also a set of users that are part of each workflow system. A set of users of a first workflow system type may overlap with a set of users of a second workflow system type. Roles or functions of each user in each particular workflow system type may be defined in workflow server 360. Each workflow system user type may be classified according to the manner with which the received fax message is processed. For example, a first user type may be an analyst while a second user type may be an editor or specialist. Imaging device 310 may query workflow server 360 to determine or identify which workflow system type should process the fax message received (block 405).

Once the workflow system type is determined or identified at block 415, imaging device 310 may determine or identify the one or more pre-identified users or user types associated with the identified workflow system type in order to determine or identify the appropriate recipient(s) of the received fax message at block 420. For example, where imaging device 310 determines, based upon the content of the fax message received, that the workflow system is a healthcare workflow, imaging device 310 may determine a recipient of the fax message among a set of users or user types identified to be part of the healthcare workflow. In one example embodiment, imaging device 310 may determine a primary recipient of the fax message by querying workflow server 360. In other example embodiments, imaging device 310 may determine the primary recipient of the fax message based upon predetermined data found in the fax message which may be used in determining the type of the fax message (block 410). In particular, imaging device 310 may determine whether the data found in the fax message matches with any of the predetermined data stored in data server 350 and whether such data is associated with a workflow system type in workflow server 360. For example, a predetermined name on the fax message may match with a name stored in data server 350, and the name may be identified to be a part of the accounting workflow.

At block 425, imaging device 310 may then determine whether the recipient identified in workflow server 360 is a registered user in active directory 315. Imaging device 310 may compare one or more users of the identified workflow system in block 415 with the one or more registered users in active directory 315 to determine whether the one or more users of the workflow are registered. In one example aspect and as shown in FIG. 3, workflow server 360 may be a component outside network 305 but communicatively connected to imaging device 310. In another example aspect, workflow server 360 may be a component within network 305.

In other example embodiments, workflow server 360 may be communicatively connected to active directory 315 to perform the determination. In this example embodiment, imaging device 310 may include an instruction to send a query to active directory 315 to check whether a first or primary workflow user identified at block 420 is a registered user in active directory 315. In yet other example embodiments, imaging device 310 may determine whether the data recognized in the fax message at block 410 (to aid in determining the type of the fax message) is associated with a user registered in active directory 315. In this embodiment, imaging device 310 may further determine the workflow system type the data is associated with in order to determine how to handle the fax message received.

At block 430, upon determining that the recipient of the fax message is registered in active directory 315, the fax message may be added to the imaging queue in print server 320 associated with the recipient. It is to be understood that users registered in active directory 315 may have corresponding imaging queues. Print server 320 may store the imaging queues of the users registered in active directory 315. Print server 320 may enqueue the fax message as an imaging job in the recipient's imaging queue. The recipient(s) may be comprised of one or more users 325. In one example embodiment, the recipient may be notified (e.g., by e-mail) when a fax message is added to his or her imaging queue.

At block 440, once added to the user's imaging queue, the fax message may remain in the recipient's imaging queue until the recipient approaches imaging device 310 and instructs imaging device 310 to print or “release” the fax message in order to obtain a hard-copy of the fax message. In one example embodiment, the recipient may be able to view a preview of the queued fax message to check or otherwise examine the contents of the fax message prior to deciding whether to print the fax message. As discussed above, when the recipient wishes to print the fax message, the recipient may log into imaging device 310 to access his or her imaging queue in print server 320 and may select the fax message from the imaging queue for printing by imaging device 310. In some example embodiments, the recipient may further process the received fax message such as, for example, by forwarding, e-mailing or storing it in addition to or in lieu of printing the fax message.

If at block 415, no workflow system is identified to be associated with the fax message, imaging device 310 may add the fax message to a predetermined imaging queue at block 435. Similarly, if at block 425 imaging device 310 determines that the recipient of the fax message is not a user registered in active directory 315, the fax message may be added to a predetermined imaging queue at block 435.

Similar to the imaging queue described at block 230 in FIG. 2, the predetermined imaging queue at block 435, may be, for example, a dedicated imaging queue for handling incoming fax messages received by one or more imaging devices 310 of network 305. The dedicated imaging queue may be used to store fax messages from unidentified recipients prior to being released by an authorized user such as, for example, a network or device administrator. Incoming fax messages that may be identified as spam or advertisements may also queued to the dedicated imaging queue and reviewed by the administrator prior to being printed or processed. The administrator may manage the predetermined imaging queue, may be notified of new fax messages received by network 305, and/or may authorize the release of the fax message for printing at imaging device 310. The administrator may control the printing of the fax message as is typical in a print release environment.

It will be understood that the example applications described herein are illustrative and should not be considered limiting. It will be appreciated that the actions described and shown in the example flowcharts may be carried out or performed in any suitable order. It will also be appreciated that not all of the actions described in FIGS. 2 and 4 need to be performed in accordance with the example embodiments of the disclosure and/or additional actions may be performed in accordance with other example embodiments of the disclosure.

Many modifications and other example embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of managing fax messages at a multi-function imaging device connected to a network, comprising:
receiving a fax message at the multi-function imaging device;
identifying a workflow system connected to the network based upon a content of the fax message;
determining a recipient based upon the workflow system; and
adding the fax message to an imaging queue associated with the recipient.

2. The method of claim 1, further comprising determining a fax message type based upon the content of the fax message, wherein the fax message type is used in the identifying the workflow system.

3. The method of claim 2, wherein the determining the fax message type is based upon an arrangement of data in the fax message.

4. The method of claim 2, further comprising extracting data from the content of the fax message and using the extracted data in the determining the fax message type.

5. The method of claim 4, wherein the extracting the data includes detecting predetermined data from the content of the fax message.

6. The method of claim 1, wherein the adding the fax message to the imaging queue associated with the recipient includes adding the fax message as a print job in the imaging queue.

7. The method of claim 1, further comprising adding the fax message to a predetermined imaging queue when at least one of: no workflow system is identified based upon the content of the fax message and no recipient is determined based upon the workflow system.

8. A system for managing fax messages, comprising:
an imaging device for receiving a fax message; and
a directory server communicatively connected to the imaging device,
wherein upon the imaging device receiving the fax message, the imaging device determines a workflow associated with the fax message based upon a content of the fax message, queries the directory server for a recipient of the fax message based upon the determined workflow, and adds the fax message as a print job to an imaging queue associated with the recipient.

9. The system of claim 8, wherein the imaging device identifies a fax message type based upon the content of the fax message and uses the fax message type to determine the workflow associated with the fax message.

10. The system of claim 9, wherein the fax message type is based upon an arrangement of data in the fax message.

11. The system of claim 9, wherein the fax message type is based upon a presence of one or more predetermined data in the content of the fax message.

12. The system of claim 8,
wherein the workflow includes one or more users, and
wherein when the imaging device queries the directory server for the recipient of the fax message, the imaging device identifies a primary recipient from the one or more users of the workflow and queries the directory server for a registered account corresponding to the primary recipient.

13. The system of claim 12, wherein when there is no registered account in the directory server corresponding to the primary recipient, the imaging device adds the fax message to a predetermined print queue.

14. The system of claim 8, further comprising a print server communicatively connected to the imaging device and the directory server, wherein the print server stores the imaging queue associated with the recipient.

15. The system of claim 8, wherein when no workflow is determined to be associated with the fax message based upon the content of the fax message, the imaging device adds the fax message to a predetermined print queue.

16. An imaging device connected to a network for managing fax messages having a non-transitory computer readable storage medium containing one or more instructions to:
receive a fax message;
determine based upon a content of the fax message a workflow connected to the network and associated with the fax message;
identify at least one recipient of the fax message based upon the workflow determined; and
send the fax message to an imaging queue associated with the at least one recipient.

17. The imaging device of claim 16, further comprising an instruction to determine a fax message type based upon a content of the fax message to determine the workflow.

18. The imaging device of claim 16, further comprising an instruction to send the fax message to a predetermined imaging queue if no workflow is determined for processing the fax message based upon the content of the fax message.

19. The imaging device of claim 16,
wherein at least one user is associated with the workflow,
wherein the imaging device is communicatively connected to a directory server storing one or more registered recipients and a print server, each of the one or more registered recipients having a corresponding imaging queue in the print server,
wherein the imaging device includes an instruction to determine whether the at least one user associated with the workflow corresponds to the one or more registered recipients in the directory server, and
wherein upon a determination that the at least one user corresponds to the one or more registered recipients in the directory server, the at least one recipient of the fax message is the at least one user associated with the workflow.

20. The imaging device of claim 19, further comprising an instruction to print the fax message when the one or more registered recipients logs into the imaging device.
